(19) United States
(12) Patent Application Publication
(10) Pub. No.: US 2026/0185015 A1
(43) Pub. Date: Jul. 2, 2026

(54) FABRIC CONDITIONER COMPOSITIONS CONTAINING CUCURBITURILS

(71) Applicant: Clariant International Ltd, Muttenz (CH)

(72) Inventors: Xiaoqiang GUO, Frankfurt am Main (DE); Carsten COHRS, Frankfurt am Main (DE); Natascha SCHELERO, Hamburg (DE); Carsten SCHAEFER, Frankfurt am Main (DE)

(73) Assignee: Clariant International Ltd, Muttenz (CH)

(21) Appl. No.: 19/132,008

(22) PCT Filed: Dec. 8, 2023
(86) PCT No.: PCT/EP2023/084999

§ 371 Date: May 22, 2025

(30) Foreign Application Priority Data
Dec. 12, 2022 (EP) 22212709.4

(51) Int. Cl. C11D 3/28; C11D 1/62

(52) U.S. Cl. CPC C11D 3/28; C11D 1/62

(57) ABSTRACT

Fabric conditioner compositions comprising one or more cucurbiturils, one or more esterquats and water are described. These fabric conditioner compositions may advantageously be used for treating fabrics through washing to remove malodor and/or to reduce malodor generated during wear after washing.

The present invention relates to fabric conditioner compositions comprising one or more cucurbiturils, one or more esterquats and water, to the use of the fabric conditioner compositions for treating fabrics through washing to remove malodor and/or to reduce malodor generated during wear after washing.

Laundry malodor is usually generated while garments are being worn. It results from soil attached to fabric being digested by microorganisms or from environmental odor adsorbed on fabric. Laundry malodor can build up on fabric over time and becomes rather persistent to removal by washing.

Fabric conditioners, also called fabric softeners, are commonly used to get fabrics softer after washing. In most fabric conditioners, high dose levels of fragrances are used to give the washed fabrics a good smell. Furthermore, high levels of fragrances are also used to mask the malodor, which is not completely removed by washing and is generated when fabrics are being worn. However, simple masking does not really solve the malodor problem, but rather creates a mixed unpleasant smell when fragrance and malodor are blended. Fragrances are volatile. Their intensity is gradually getting lower over time. Thus, the masking effect also decreases and eventually malodor takes over. Furthermore, some fragrances are allergens which can cause allergic reactions to some groups of consumers.

Instead of masking, some fragrance components were found to be able to counteract sensory perception of certain odorants. WO 2019/130207 A1 describes compositions and a method for counteracting or masking malodor in laundry articles, comprising providing a laundry composition comprising 3-benzyl-tetrahydropyran; combining the laundry composition with a liquid medium for contacting the laundry articles, wherein a concentration of 3-benzyl-tetrahydropyran in the laundry composition is at least 15 ppm based on the total mass of the laundry; and contacting the laundry articles with the liquid medium comprising the laundry composition. However, such counteracting agents only work for certain malodor molecules. Due to the loss caused by their high volatility, they can only work for a short period of time.

There is still a need for malodor combating technology, which can be used for treating fabrics through washing to remove malodor and/or to reduce malodor generated during wear after washing.

The object of the present invention is to provide fabric conditioner compositions which can be used for treating fabrics through washing to remove malodor and/or to reduce malodor generated during wear after washing.

It has been found that this object is achieved by fabric conditioner compositions comprising
Z1) one or more cucurbiturils selected from the group consisting of cucurbit[5]uril, cucurbit[6]uril, cucurbit[7]uril, cucurbit[8]uril and mixtures thereof,
and
Z2) one or more esterquats selected from the formula (Ia)

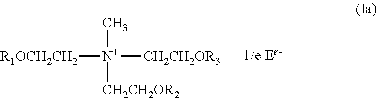

wherein
R₁, R₂ and R₃ are, independently of one another, hydrogen, a linear or branched alkanoyl group or a linear or branched alkenoyl group, whereby at least one of R₁, R₂ and R₃ is not hydrogen, and
1/e E^{e-} is an anion, preferably selected from the group consisting of monovalent anions E⁻ (e=1), divalent anions ½ E²⁻ (e=2) and trivalent anions⅓ E³⁻ (e=3) and more preferably selected from the group consisting of C⁻ (chloride), Br⁻ (bromide), CH₃—SO⁴⁻ (methyl sulfate), C₂H₅—SO⁴⁻ (ethyl sulfate), HCOO⁻ (formate), ⅓ C(OH)(COO⁻)(CH₂COO⁻)₂ (citrate), CH₃—COO⁻ (acetate), NO₃⁻ (nitrate), ½ CO₃²⁻ (carbonate), ½ SO₄²⁻ (sulfate) and⅓ PO₄³⁻ (phosphate)
and
Z3) water.

A subject matter of the present invention therefore is fabric conditioner compositions comprising
Z1) one or more cucurbiturils selected from the group consisting of cucurbit[5]uril, cucurbit[6]uril, cucurbit[7]uril, cucurbit[8]uril and mixtures thereof,
and
Z2) one or more esterquats selected from the formula (Ia)

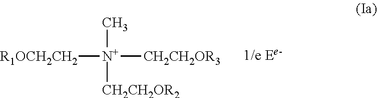

wherein
R₁, R₂ and R₃ are, independently of one another, hydrogen, a linear or branched alkanoyl group or a linear or branched alkenoyl group, whereby at least one of R₁, R₂ and R₃ is not hydrogen, and
1/e E^{e-} is an anion, preferably selected from the group consisting of monovalent anions E⁻ (e=1), divalent anions ½ E²⁻ (e=2) and trivalent anions⅓ E³⁻ (e=3) and more preferably selected from the group consisting of C⁻ (chloride), Br⁻ (bromide), CH₃—SO⁴⁻ (methyl sulfate), C₂H₅—SO⁴⁻ (ethyl sulfate), HCOO⁻ (formate), ⅓ C(OH)(COO⁻)(CH₂COO⁻)₂ (citrate), CH₃—COO⁻ (acetate), NO₃⁻ (nitrate), ½ CO₃²⁻ (carbonate), ½ SO₄²⁻ (sulfate) and⅓ PO₄³⁻ (phosphate)
and
Z3) water.

Cucurbiturils are barrel-like molecules which can be prepared according to the process described in U.S. Pat. No. 10,626,119 B2.

The inventive fabric conditioner compositions have the advantage that they can be used for treating fabrics through washing to remove malodor and/or to reduce malodor generated during wear after washing.

The term “malodor generated during wear” in the context of the invention refers to the fact that during wear of fabrics malodor can be produced, e.g. because dirt or fatty soils attached to fabrics are continuously being degraded by microorganisms present on fabrics.

Preferably, component Z1) of the inventive fabric conditioner compositions comprises
a) cucurbit[5]uril in an amount from 0 to 20% by weight, more preferably in an amount from 0 to 10% by weight and even more preferably in an amount from 0 to 5% by weight; and
b) cucurbit[6]uril in an amount from 30 to 70% by weight, more preferably in an amount from 35 to 65% by weight and even more preferably in an amount from 40 to 60% by weight; and
c) cucurbit[7]uril in an amount from 20 to 50% by weight, more preferably in an amount from 25 to 45% by weight and even more preferably in an amount from 30 to 40% by weight; and
d) cucurbit[8]uril in an amount from 0 to 30% by weight, more preferably in an amount from 0 to 20% by weight and even more preferably in an amount from 5 to 15% by weight;

in each case based on the total weight of component Z1).

In a more preferred embodiment of the invention, component Z1) of the inventive fabric conditioner compositions comprises
a) cucurbit[5]uril in an amount from 0 or 0.1 to 20% by weight, even more preferably in an amount from 0 or 0.1 to 10% by weight and particularly preferably in an amount from 0 or 0.1 to 5% by weight; and
b) cucurbit[6]uril in an amount from 30 to 69.9% by weight, even more preferably in an amount from 35 to 64.9% by weight and particularly preferably in an amount from 40 to 59.9% by weight; and
c) cucurbit[7]uril in an amount from 20 to 50% by weight, even more preferably in an amount from 25 to 45% by weight and particularly preferably in an amount from 30 to 40% by weight; and
d) cucurbit[8]uril in an amount from 0 to 30% by weight, even more preferably in an amount from 0 to 20% by weight and particularly preferably in an amount from 5 to 15% by weight;
in each case based on the total weight of component Z1).

In a preferred embodiment of the invention, the lower limit of cucurbit[5]uril in component Z1) of the inventive fabric conditioner compositions is 0.1% by weight, based on the total weight of component Z1).

Preferably, the one or more esterquats of component Z2) of the fabric conditioner compositions according to the invention are selected from the formula (Ia) wherein
R₁ is hydrogen,
R₂ and R₃ are, independently of one another, hydrogen, a linear or branched C8-C18 alkanoyl group or a linear or branched C8-C18 alkenoyl group, whereby at least one of R₂ and R₃ is not hydrogen, preferably hydrogen, a linear C8-C18 alkanoyl group or a linear C8-C18 alkenoyl group, whereby at least one of R₂ and R₃ is not hydrogen, more preferably hydrogen, a linear C14-C18 alkanoyl group or a linear C14-C18 alkenoyl group, whereby at least one of R₂ and R₃ is not hydrogen, and even more preferably hydrogen, a stearoyl group or an oleoyl group, whereby at least one of R₂ and R₃ is not hydrogen, and
1/e E^{e-} is an anion, preferably selected from the group consisting of monovalent anions E⁻ (e=1), divalent anions ½ E²⁻ (e=2) and trivalent anions⅓ E³⁻ (e=3) and more preferably selected from the group consisting of C⁻ (chloride), Br⁻ (bromide), CH₃—SO⁴⁻ (methyl sulfate), C₂H₅—SO⁴⁻ (ethyl sulfate), HCOO⁻ (formate), ⅓ C(OH)(COO⁻)(CH₂OOO⁻)₂ (citrate), CH₃—COO⁻ (acetate), NO₃ (nitrate), ½ CO₃²⁻ (carbonate), ½ SO₄²⁻ (sulfate) and⅓ PO₄³⁻ (phosphate).

In a more preferred embodiment of the invention, the one or more esterquats of component Z2) of the fabric conditioner compositions according to the invention are selected from the formula (Ia) wherein
R₁ is hydrogen,
R₂ and R₃ are, independently of one another, hydrogen or a stearoyl group, whereby at least one of R₂ and R₃ is a stearoyl group and preferably both, R₂ and R₃, are a stearoyl group, and
1/e E^{e-} is an anion, preferably selected from the group consisting of monovalent anions E⁻ (e=1), divalent anions ½ E²⁻ (e=2) and trivalent anions⅓ E³⁻ (e=3) and more preferably selected from the group consisting of Cl⁻ (chloride), Br⁻ (bromide), CH₃—SO⁴⁻ (methyl sulfate), C₂H₅—SO⁴⁻ (ethyl sulfate), HCOO⁻ (formate), ⅓ C(OH)(COO⁻)(CH₂OOO⁻)₂ (citrate), CH₃—COO⁻ (acetate), NO₃ (nitrate), ½ CO₃²⁻ (carbonate), ½ SO₄²⁻ (sulfate) and⅓ PO₄³⁻ (phosphate).

In another more preferred embodiment of the invention, the one or more esterquats of component Z2) of the fabric conditioner compositions according to the invention are selected from the formula (Ia) wherein
R₁ is hydrogen,
R₂ and R₃ are, independently of one another, hydrogen or an oleoyl group, whereby at least one of R₂ and R₃ is an oleoyl group and preferably both, R₂ and R₃, are an oleoyl group, and
1/e E^{e-} is an anion, preferably selected from the group consisting of monovalent anions E⁻ (e=1), divalent anions ½ E²⁻ (e=2) and trivalent anions⅓ E³⁻ (e=3) and more preferably selected from the group consisting of Cl⁻ (chloride), Br⁻ (bromide), CH₃—SO⁴⁻ (methyl sulfate), C₂H₅—SO⁴⁻ (ethyl sulfate), HCOO⁻ (formate), ⅓ C(OH)(COO⁻)(CH₂COO⁻)₂ (citrate), CH₃—COO⁻ (acetate), NO₃⁻ (nitrate), ½ CO₃²⁻ (carbonate), ½ SO₄²⁻ (sulfate) and⅓ PO₄³⁻ (phosphate).

Preferably, the fabric conditioner compositions according to the invention comprise the one or more cucurbiturils of component Z1) in an amount from 0.01 to 5% by weight, more preferably in an amount from 0.01 to 2% by weight and even more preferably in an amount from 0.01 to 1% by weight, in each case based on the total weight of the fabric conditioner compositions.

Preferably, the fabric conditioner compositions according to the invention comprise the one or more esterquats of component Z2) in an amount from 1 to 20% by weight, more preferably in an amount from 2 to 18% by weight and even more preferably in an amount from 2 to 15% by weight, in each case based on the total weight of the fabric conditioner composition.

Preferably, the fabric conditioner compositions according to the invention comprise
the one or more cucurbiturils of component Z1) in an amount from 0.01 to 5% by weight, more preferably in an amount from 0.01 to 2% by weight and even more preferably in an amount from 0.01 to 1% by weight; and
the one or more esterquats of component Z2) in an amount from 1 to 20% by weight, more preferably in an amount from 2 to 18% by weight and even more preferably in an amount from 2 to 15% by weight; and
water of component Z3) in an amount from 79.99 to 98.99% by weight, more preferably in an amount from 81.99 to 97.99% by weight and even more preferably in an amount from 84.99 to 97.99% by weight,

in each case based on the total weight of the fabric conditioner composition.

Preferably, the fabric conditioner compositions according to the invention comprise a further component Z4)
Z4) one or more substances selected from
a) one or more discrete molecules containing nitrogen and different from the esterquats of the formula (Ia) of component Z2), or
b) one or more polymers comprising one or more structural units derived from one or more monomers containing nitrogen, or mixtures thereof.

The one or more structural units of the one or more polymers b) of component Z4) of the fabric conditioner compositions according to the invention encompass repeating structural units and terminal groups.

A discrete molecule a) of component Z4) of the fabric conditioner compositions according to the invention refers to a non-polymeric molecule with a defined chemical structure and a defined molar mass.

Preferably, the one or more discrete molecules a) of component Z4) of the fabric conditioner compositions according to the invention are selected from the group consisting of amine oxides, betaines, quats (different from the esterquats of the formula (Ia) of component Z2)), glucamides, glucamines, and mixtures thereof.

Preferably, the amine oxides are alkyl and/or alkenyl amine oxides, more preferably alkyl amine oxides and even more preferably C8-C18 alkylamine oxides, and alkyl and/or alkenyl dimethyl amine oxides, more preferably alkyl dimethyl amine oxides and even more preferably C8-C18 alkyl dimethyl amine oxides.

In a particularly preferred embodiment of the invention, the amine oxides are selected from the group consisting of cocamine oxide, myristyl dimethylamine oxide, lauryl dimethylamine oxide, octyl dimethylamine oxide, and mixtures thereof.

Among the alkyl and/or alkenyl amine oxides, the alkyl amine oxides are preferred. Among the alkyl and/or alkenyl dimethyl amine oxides, the alkyl dimethyl amine oxides are preferred.

Preferably, the betaines are alkyl and/or alkenyl dimethyl betaines, more preferably C8-C18 alkyl and/or alkenyl dimethyl betaines and even more preferably C8-C16 alkyl dimethyl betaines, and alkyl and/or alkenyl amido propyl betaines, more preferably C8-C18 alkyl and/or alkenyl amido propyl betaines and even more preferably C8-C16 alkyl amido propyl betaines.

In a particularly preferred embodiment of the invention, the betaines are selected from the group consisting of cocoyl dimethyl betaine, myristyl dimethyl betaine, lauryl dimethyl betaine, octyl dimethyl betaine, cocamidopropyl betaine, and mixtures thereof.

Among the alkyl and/or alkenyl dimethyl betaines, the alkyl dimethyl betaines are preferred. Among the alkyl and/or alkenyl amido propyl betaines, the alkyl amido propyl betaines are preferred.

Preferably, the quats of component Z4) of the fabric conditioner compositions according to the invention are selected from the formula (IX)

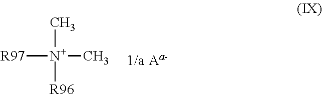

wherein
R96 is a linear alkyl group having 1 to 6 carbon atoms, preferably 1 to 4 carbon atoms, and more preferably is a methyl group; or a linear hydroxylalkyl group having 1 to 6 carbon atoms, preferably 1 to 4 carbon atoms, and more preferably is a hydroxylethyl group,
R97 is a linear or branched, preferably a linear, alkyl group having 8 to 22 and preferably 8 to 18 carbon atoms, and
1/a A^{a-} is an anion, preferably selected from the group consisting of monovalent anions A⁻ (a=1), divalent anions % A²⁻ (a=2) and trivalent anions⅓ A³⁻ (a=3) and more preferably selected from the group consisting of C⁻ (chloride), Br⁻ (bromide), CH₃—SO⁴⁻ (methyl sulfate), C₂H₅—SO⁴⁻ (ethyl sulfate), HCOO⁻ (formate), ⅓ C(OH)(COO⁻)(CH₂COO⁻)₂ (citrate), CH₃—COO (acetate), NO₃⁻ (nitrate), ½ C03²⁻ (carbonate), ½ SO₄²⁻ (sulfate) and ⅓ PO₄³⁻(phosphate).

In a more preferred embodiment of the invention, in formula (IX),
R96 is a hydroxylethyl group,
R97 is a linear alkyl group having 8 to 10 carbon atoms, and
1/a A^{a-} is an anion, preferably selected from the group consisting of monovalent anions A⁻ (a=1), divalent anions ½ A²⁻ (a=2) and trivalent anions⅓ A³⁻ (a=3) and more preferably selected from the group consisting of C⁻ (chloride), Br⁻ (bromide), CH₃—SO⁴⁻ (methyl sulfate), C₂H₅—SO⁴⁻ (ethyl sulfate), HCOO⁻ (formate), ⅓ C(OH)(COO⁻)(CH₂COO⁻)₂ (citrate), CH₃—COO⁻ (acetate), NO₃⁻ (nitrate), ½ CO₃²⁻ (carbonate), ½ SO₄²⁻ (sulfate) and ⅓ PO₄³⁻ (phosphate).

In a further, more preferred embodiment of the invention, in formula (IX),
R96 is a hydroxylethyl group,
R97 is a linear alkyl group having 12 to 14 carbon atoms, and
1/a A^{a-} is an anion, preferably selected from the group consisting of monovalent anions A⁻ (a=1), divalent anions ½ A²⁻ (a=2) and trivalent anions⅓ A³⁻ (a=3) and more preferably selected from the group consisting of C⁻ (chloride), Br⁻ (bromide), CH₃—SO⁴⁻ (methyl sulfate), C2H₅—SO⁴⁻ (ethyl sulfate), HCOO⁻ (formate), ⅓ C(OH)(COO⁻)(CH₂COO⁻)₂ (citrate), CH₃—COO⁻ (acetate), NO₃⁻ (nitrate), ½ C03²⁻ (carbonate), ½ SO₄²⁻ (sulfate) and ⅓ PO₄³⁻ (phosphate).

Preferably, the glucamides are N-hydrocarbon substituted-N-acyl-glucamides of the formula (X)

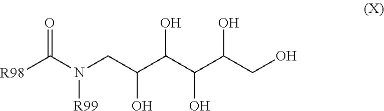

wherein
R98 is a linear or branched, preferably a linear, alkyl group having 7 to 21 and preferably 7 to 17 carbon atoms, or a linear or branched, preferably a linear, alkenyl group having one or more double bonds and 7 to 21, preferably 7 to 17, carbon atoms, and
R99 is a linear or branched, preferably a linear, alkyl group having 1 to 6 carbon atoms, more preferably a methyl, ethyl, propyl or butyl group, and even more preferably a methyl group.

More preferably,
R98CO in formula (X) is selected from the group consisting of capryloyl, pelargonoyl, caprinoyl, undecyloyl, lauroyl, tridecyloyl, myristoyl, pentadecyloyl, palmitoyl, margaroyl, stearoyl, myristoleoyl, pamitoleoyl, oleoyl, linolenoyl, and mixtures thereof.

In an even more preferred embodiment of the invention, in formula (X),
R98 is a linear alkyl group having 11 to 13 carbon atoms and
R99 is a methyl group, or
R98CO derives from coconut oil and
R99 is a methyl group, or
R98CO derives from sunflower oil and
R99 is a methyl group.

In a particularly preferred embodiment of the invention, in formula (X),
R98 is a linear alkyl group having 11 to 13 carbon atoms and
R99 is a methyl group.

In a further particularly preferred embodiment of the invention, in formula (X),
R98CO derives from coconut oil and
R99 is a methyl group.

In a further particularly preferred embodiment of the invention, in formula (X),
R98CO derives from sunflower oil and
R99 is a methyl group.

Preferably, the glucamines are selected from the compounds of the formula (IV)

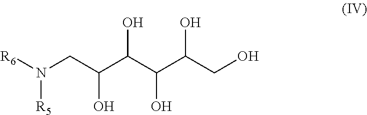

wherein
R5 and R6 are, independently of one another, hydrogen, a linear or branched alkyl group having 1 to 20 carbon atoms or a linear or branched alkenyl group having 2 to 20 carbon atoms, preferably hydrogen, a linear or branched alkyl group having 1 to 16 carbon atoms or a linear or branched alkenyl group having 2 to 16 carbon atoms, more preferably hydrogen, a linear or branched alkyl group having 1 to 10 carbon atoms or a linear or branched alkenyl group having 2 to 10 carbon atoms, even more preferably hydrogen, a linear or branched alkyl group having 1 to 4 carbon atoms or a linear or branched alkenyl group having 2 to 4 carbon atoms, and particularly preferably, are methyl groups.

Preferably, the one or more polymers b) of component Z4) of the fabric conditioner compositions according to the invention comprise one or more structural units derived from one or more monomers of the formulae (I), (II-a), (II-b), (II-c), (III), N-methyl-N-alkylamines, aziridine, vinylpyrrolidone, vinylimidazole, or mixtures thereof

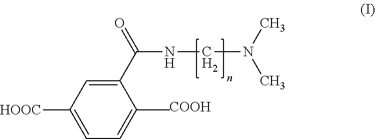

wherein
n is an integer from 1 to 20, preferably from 1 to 10, more preferably from 1 to 6, even more preferably is 2 or 3, and particularly preferably is 3,

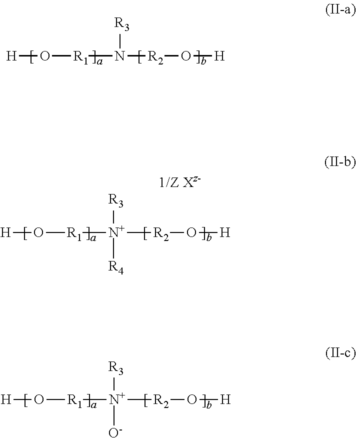

wherein
R₁ and R₂ are, independently of one another, selected from linear or branched alkylene groups represented by the formula (CₙH₂ₙ) wherein n is 2, 3 or 4,
R₃ is a group of the formula —(CⱼH₂j_{O})ₖ—R₉₈, wherein j is 2, 3 or 4, preferably 2, k is, based on a molar average, a number from 0 to 10, preferably from 0 to 5, more preferably from 0 to 2 and even more preferably is 0, and R₉₈ is selected from the group consisting of alkyl, alkenyl, hydroxyalkyl, hydroxyalkenyl, phenyl alkyl, phenyl alkenyl, alkyl phenyl, and alkenyl phenyl, wherein the alkyl and alkenyl groups, either as such or as a part of the aforementioned hydroxyalkyl, hydroxyalkenyl, phenyl alkyl, phenyl alkenyl, alkyl phenyl or alkenyl phenyl groups, contain 6 or more than 6 carbon atoms, preferably from 6 to 30 carbon atoms and more preferably from 6 to 22 carbon atoms,
R₄ is a group of the formula —(Cⱼ₁H₂ⱼ₁O)ₖ₁—R₉₉, wherein j1 is 2, 3 or 4, preferably 2, k1 is, based on a molar average, a number from 0 to 10, preferably from 0 to 5, more preferably from 0 to 2 and even more preferably is 0, and R₉₉ is selected from the group consisting of hydrogen, alkyl, alkenyl, hydroxyalkyl, hydroxyalkenyl, phenyl alkyl, phenyl alkenyl, alkyl phenyl, and alkenyl phenyl, wherein the alkyl groups, either as such or as a part of the aforementioned hydroxyalkyl, phenyl alkyl or alkyl phenyl groups, contain from 1 to 30 carbon atoms, preferably from 1 to 22 carbon atoms and more preferably from 1 to 6 carbon atoms, and wherein the alkenyl groups, either as such or as a part of the aforementioned hydroxyalkenyl, phenyl alkenyl or alkenyl phenyl groups, contain from 2 to 30 carbon atoms, preferably from 2 to 22 carbon atoms and more preferably from 2 to 6 carbon atoms,
a and b are, based on a molar average, independently of one another, numbers from 1 to 200, preferably from 1 to 100, more preferably from 1 to 50, even more preferably from 1 to 25, and particularly preferably from 1 to 10, and
1/Z X^{z-} is an anion, preferably selected from the group consisting of monovalent anions X⁻ (z=1), divalent anions ½ X²⁻ (z=2) and trivalent anions⅓ X³⁻ (z=3) and more preferably selected from the group consisting of C⁻ (chloride), Br⁻ (bromide), CH₃—SO⁴⁻ (methyl sulfate), C₂H₅—SO⁴⁻ (ethyl sulfate), HCOO⁻ (formate),
⅓ C(OH)(COO⁻)(CH₂COO⁻)₂ (citrate), CH₃—COO⁻ (acetate), NO₃⁻ (nitrate), ½ CO₃²⁻ (carbonate), ½ SO₄²⁻ (sulfate) and⅓ PO₄³⁻ (phosphate),

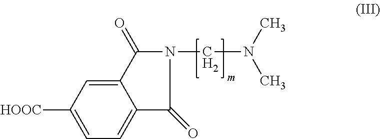

wherein
m is an integer from 1 to 20, preferably from 1 to 10, more preferably from 1 to 6, even more preferably is 2 or 3, and particularly preferably is 3.

In a more preferred embodiment of the invention, the one or more polymers b) of component Z4) of the fabric conditioner compositions according to the invention comprise one or more structural units derived from one or more monomers of the formulae (I), (II-a), (II-b), (II-c), (III), or mixtures thereof. These polymers b) are polyesters.

In an even more preferred embodiment of the invention, the one or more polymers b) of component Z4) of the fabric conditioner compositions according to the invention that comprise one or more structural units derived from one or more monomers of the formulae (I), (II-a), (II-b), (II-c), (Ill), or mixtures thereof, further comprise
A) one or more structural units derived from terephthalic acid or dimethyl terephthalate, and
B) one or more structural units derived from ethylene glycol or propylene glycol.

In a particularly preferred embodiment of the invention, the one or more polymers b) of component Z4) of the fabric conditioner compositions according to the invention that comprise one or more structural units derived from one or more monomers of the formulae (I), (II-a), (II-b), (II-c), (Ill), or mixtures thereof, and further comprise one or more structural units A) and one or more structural units B), further comprise one or more structural units derived from one or more polyalkyleneglycol monoalkylethers of the formula (V)

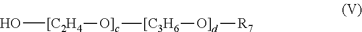

wherein,
R₇ is linear or branched (C₁-C₃₀)-alkyl, preferably linear or branched (C₁-C₄)-alkyl, and more preferably methyl,
c and d are, based on a molar average, independently of one another, numbers from 0 to 200, and the sum of c+d is from 2 to 400, preferably from 2 to 350 and more preferably from 2 to 150, the [C₂H₄—O] and [C₃H₆—O]groups of the formula (V) may be arranged blockwise, alternating, periodically and/or statistically, preferably blockwise and/or statistically, and either of the [C₂H₄—O] and [C₃H₆—O]groups of the formula (V) can be linked to —R₇ and/or —OH.

In an extraordinarily preferred embodiment of the invention, the one or more polymers b) of component Z4) of the fabric conditioner compositions according to the invention are selected from the group consisting of polymers comprising one or more structural units derived from one or more monomers of the formulae (I) or (Ill) or mixtures thereof, and one or more structural units derived from one or more monomers of the formula (V), and one or more structural units of the component A) and one or more structural units of the component B);

polymers comprising one or more structural units derived from one or more monomers of the formula (II-a), and one or more structural units derived from one or more monomers of the formula (V), and one or more structural units of the component A) and one or more structural units of the component B); polymers comprising one or more structural units derived from one or more monomers of the formula (II-b), and one or more structural units derived from one or more monomers of the formula (V), and one or more structural units of the component A) and one or more structural units of the component B); and polymers comprising one or more structural units derived from one or more monomers of the formula (II-c), and one or more structural units derived from one or more monomers of the formula (V), and one or more structural units of the component A) and one or more structural units of the component B).

In a further, more preferred embodiment of the invention, the one or more polymers b) of component Z4) of the fabric conditioner compositions according to the invention comprise one or more structural units derived from one or more N-methyl-N-alkylamines, aziridine, or mixtures thereof.

In an even more preferred embodiment of the invention, the one or more polymers b) of component Z4) of the fabric conditioner compositions according to the invention that comprise one or more structural units derived from one or more N-methyl-N-alkylamines further comprise one or more structural units derived from epichlorohydrin. Particularly preferably, the alkyl group in the N-methyl-N-alkylamine is methyl (N,N-dimethylamines). An extraordinarily preferred example is Texcare DFC 6 pre, a dimethylamine-epichlorohydrin copolymer.

In another even more preferred embodiment of the invention, the one or more polymers b) of component Z4) of the fabric conditioner compositions according to the invention that comprise one or more structural units derived from aziridine further comprise one or more structural units derived from ethylene oxide. A particularly preferred example is Sokalan HP 56, an ethoxylated polyethyleneimine.

In a further, more preferred embodiment of the invention, the one or more polymers b) of component Z4) of the fabric conditioner compositions according to the invention comprise one or more structural units derived from vinylpyrrolidone, vinylimidazole, or mixtures thereof.

In an even more preferred embodiment of the invention, the one or more polymers b) of component Z4) of the fabric conditioner compositions according to the invention comprise one or more structural units derived from vinylpyrrolidone and one or more structural units derived from vinylimidazole. A particularly preferred example is Sokalan HP 56 K, a vinylpyrrolidone/vinylimidazole copolymer.

Preferably, the fabric conditioner compositions according to the invention comprise the one or more substances of component Z4) in an amount from 0.01 to 20% by weight, more preferably in an amount from 0.01 to 10% by weight and even more preferably in an amount from 0.01 to 5% by weight, in each case based on the total weight of the fabric conditioner compositions.

Preferably, the fabric conditioner compositions according to the invention comprise further components typically used therein and known to the person skilled in the art, such as fragrances, preservatives or thickeners.

The fabric conditioner compositions according to the invention may advantageously be used for treating fabrics through washing to remove malodor and/or to reduce malodor generated during wear after washing.

A further subject matter of the present invention is the use of fabric conditioner compositions according to the invention for treating fabrics through washing to remove malodor.

A further subject matter of the present invention is the use of fabric conditioner compositions according to the invention for treating fabrics through washing to reduce malodor generated during wear after washing.

The examples below are intended to illustrate the invention in detail without, however, limiting it thereto.

Example 1—Preparation of fabric conditioner compositions Two fabric conditioner compositions were prepared as described in Table 1.

TABLE 1
Fabric conditioner compositions A and B

| | A | B |
|---|---|---|
| | (comparative) | (inventive) |
| | amount of | amount of |
| | ingredient | ingredient |
| Ingredient | [% by weight] | [% by weight] |
| Praepagen TQ | 5 | 5 |
| (an esterquat according to the | | |
| formula (Ia), wherein R₁ is hydrogen, | | |
| R₂ and R₃ are stearoyl) | | |
| Cucurbituril sample comprising | 0 | 0.5 |
| cucurbit[6]uril (50% by weight), | | |
| cucurbit[7]uril (35% by weight) and | | |
| cucurbit[8]uril (10% by weight) | | |
| Water | add up to 100 | add up to 100 |

### EXAMPLE 2—PROCEDURE OF SENSORY TESTS AND RESULTS

### Treatment of Cotton Fabric:

Fabric conditioner compositions A and B, 20 g each, from example 1 were diluted in 5 L water in separate buckets. Twenty pieces of cotton towel (each of the size of 20 cm×20 cm) were then soaked in the aqueous mixtures for 1 hour (ten pieces of cotton towel in the aqueous mixture comprising fabric conditioner composition A and the other ten pieces of cotton towel in the aqueous mixture comprising fabric conditioner composition B) and these aqueous mixtures were stirred from time to time. The towels were then taken out of the buckets and the excess water was wringed out. The towels were hanged on a drying rack to dry overnight.

### Malodor Composition:

An artificial malodor composition was prepared by mixing 10 mg of 2,3-butanedione, 5 mg of octanal, 30 mg of isovaleraldehyde, 300 mg of isovaleric acid and 50 mg of hexanal in 1 L of water.

Sensory Test—a 2-Alternative Forced-Choice Test: Each towel was then cut into 16 pieces of 5 cm×5 cm swatches. Each swatch was then sprayed with 0.1 g of malodor composition and left on a laboratory bench for 30 minutes before the sensory test.

From the 320 swatches 40 swatches were used for the sensory test. Each panelist received two test swatches: one swatch that had been treated with the aqueous mixture comprising fabric conditioner composition A (comparative), and another swatch that had been treated with the aqueous mixture comprising fabric conditioner composition B (inventive).

Panelists were asked to sniff both swatches and each panelist had to decide which of the two swatches was the stronger smelling swatch.

In total, there were 20 untrained panelists. Fourteen panelists chose the swatches treated with the aqueous mixture comprising the fabric conditioner composition A (comparative) as the stronger smelling swatch. This shows that the malodor intensity of the swatches treated with the aqueous mixture comprising fabric conditioner composition A (comparative) is higher than of the swatches treated with the aqueous composition comprising fabric conditioner composition B (inventive).

1-9. (canceled)

10. A fabric conditioner composition comprising
Z1) one or more cucurbiturils selected from the group consisting of cucurbit[5]uril, cucurbit[6]uril, cucurbit[7]uril, cucurbit[8]uril, and mixtures thereof;
Z2) one or more esterquats of the formula (Ia) 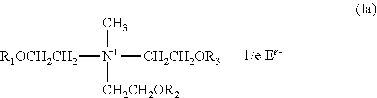
wherein
R₁, R₂, and R₃ are each, independently, hydrogen, a linear or branched alkanoyl group or a linear or branched alkenoyl group, whereby at least one of R₁, R₂ and R₃ is not hydrogen, and
1/e E^{e-} is an anion selected from the group consisting of monovalent anions E⁻ (e=1), divalent anions ½ E²⁻ (e=2), and trivalent anions ⅓ E³⁻ (e=3);
and
Z3) water.

11. The fabric conditioner composition according to claim 10, wherein component Z1) comprises
a) cucurbit[5]uril in an amount of from 0 to 20% by weight,
b) cucurbit[6]uril in an amount of from 30 to 70% by weight,
c) cucurbit[7]uril in an amount of from 20 to 50% by weight, and
d) cucurbit[8]uril in an amount of from 0 to 30% by weight,
in each case based on the total weight of component Z1).

12. The fabric conditioner composition according to claim 10, wherein component Z1) comprises
a) cucurbit[5]uril in an amount of from 0.1 to 5% by weight,
b) cucurbit[6]uril in an amount of from 40 to 59.9% by weight,
c) cucurbit[7]uril in an amount of from 30 to 40% by weight, and
d) cucurbit[8]uril in an amount of from 5 to 15% by weight,
in each case based on the total weight of component Z1).

13. The fabric conditioner composition according to claim 10, wherein
R₁ is hydrogen, and
R₂ and R₃ are each, independently, hydrogen, a linear or branched C₈-C₁₈ alkanoyl group, or a linear or branched C₈-C₁₈ alkenoyl group, whereby at least one of R₂ and R₃ is not hydrogen.

14. The fabric conditioner composition according to claim 10, wherein
R₁ is hydrogen, and
R₂ and R₃ are each, independently, hydrogen or a stearoyl group, whereby at least one of R₂ and R₃ is a stearoyl group.

15. The fabric conditioner composition according to claim 10, wherein
R₁ is hydrogen, and
R₂ and R₃ are each, independently, hydrogen or an oleyl group, whereby at least one of R₂ and R₃ is an oleyl group.

16. The fabric conditioner composition according to claim 10, wherein 1/e E^{e-} is an anion selected from the group consisting of chloride, bromide, methyl sulfate, ethyl sulfate, formate, citrate, acetate, nitrate, carbonate, sulfate, and phosphate.

17. The fabric conditioner composition according to claim 10, wherein the composition comprises the one or more cucurbiturils of component Z1) in an amount of from 0.01 to 5% by weight, based on the total weight of the fabric conditioner composition.

18. The fabric conditioner composition according to claim 10, wherein the composition comprises the one or more esterquats of component Z2) in an amount of from 1 to 20% by weight, based on the total weight of the fabric conditioner composition.

19. The fabric conditioner composition according to claim 10, wherein the composition comprises the one or more cucurbiturils of component Z1) in an amount of from 0.01 to 2% by weight, based on the total weight of the fabric conditioner composition.

20. The fabric conditioner composition according to claim 10, wherein the composition comprises the one or more esterquats of component Z2) in an amount of from 2 to 18% by weight, based on the total weight of the fabric conditioner composition.

21. A method of treating a fabric to remove malodor, the method comprising the step of bringing the fabric into contact with the composition of claim 10.

22. A fabric conditioner composition comprising
Z1) cucurbit[5]uril in an amount of from 0 to 20% by weight, cucurbit[6]uril in an amount of from 40 to 60% by weight, cucurbit[7]uril in an amount of from 25 to 45% by weight, and cucurbit[8]uril in an amount of from 5 to 15% by weight, in each case based on the total weight of component Z1);
Z2) one or more esterquats of the formula (Ia) 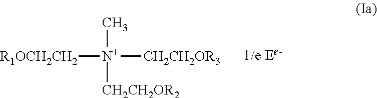
wherein
R₁ is hydrogen,
R₂ and R₃ are each, independently, hydrogen, a linear or branched C₈-C₁₈ alkanoyl group, or a linear or branched C₈-C₁₈ alkenoyl group, whereby at least one of R₂ and R₃ is not hydrogen,
and
1/e E^{e-} is an anion selected from the group consisting of chloride, bromide, methyl sulfate, ethyl sulfate, formate, citrate, acetate, nitrate, carbonate, sulfate, and phosphate;
and
Z3) water.

23. The fabric conditioner composition according to claim 22, wherein R₂ and R₃ are each, independently, hydrogen, a stearoyl group, or an oleyl group, whereby at least one of R₂ and R₃ is not hydrogen.

24. The fabric conditioner composition according to claim 22, wherein the composition comprises, based on the total weight of the fabric conditioner composition, the one or more cucurbiturils of component Z1) in an amount of from 0.01 to 5% by weight and the one or more esterquats of component Z2) in an amount of from 1 to 20% by weight.
